(19) United States
(12) Patent Application Publication
(10) Pub. No.: US 2006/0132079 A1
(43) Pub. Date: Jun. 22, 2006

(54) Self-traveling cleaning robot

(75) Inventor: Hiroyuki Takenaka, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/313,578

(22) Filed: Dec. 21, 2005

(30) Foreign Application Priority Data
Dec. 21, 2004 (JP) 2004-369957

(51) Int. Cl. G05D 1/00; B64C 13/18

(52) U.S. Cl. 318/587

(57) ABSTRACT

A self-traveling cleaning robot includes: a stepped portion detecting unit for detecting a stepped portion of a floor arranged on the center front part of the bottom of the robot main body; an angle detecting unit for detecting the rotation angle of the main body in horizontal direction of the main body; and a travel control unit for controlling a travel based on the detection output of the stepped portion detecting unit and the angle detecting unit, wherein the travel control unit stops when a stepped portion is detected by the stepped portion detecting unit, and rotates to the left and to the right in that state thus detecting the rotation angle up to the boundary of the stepped portion in each direction by way of the angle detecting unit, thereby correcting the posture of the robot main body based on the detected angle.

### BACKGROUND OF THE INVENTION

1. Field of the Invention

The present invention relates to a self-traveling cleaning robot that cleans a room floor along a predetermined planned line.

2. Description of the Related Art

There is known in the related art a self-traveling cleaning robot that cleans a room floor along a predetermined planned line. In particular, self-traveling cleaning robots that perform various types of travel operations in accordance with stepped portions of a floor have been proposed (for example, refer to JP-A-2004-139264 and JP-UM-A-6-30807).

The self-traveling robot described in JP-A-2004-139264 detects a stepped portion by calculating the distance from the main body and the floor surface by using a light receiving unit including a light receiver that receives light beams irradiated from a light emitter during a self travel. The self-traveling robot, detecting a recessed step 71 such as a downward staircase, an open dust-window and a vestivule earth floor as shown in the state B in FIG. 7A, temporarily stops as shown in the state C in FIG. 7B, and rotates to the right until it no longer detects a stepped portion. Then, as shown in the state D in FIG. 7C, the self-traveling robot further rotates to the right by a predetermined angle, turns around in a curve with respect to the stepped portion ad shown in the state E in FIG. 7C. Detecting a recessed step 71 again as shown in the state F, the self-traveling robot temporarily stops, rotates to the right and turns around. This allows the main body to travel along the recessed step 71 while drawing a plurality of mountain-shaped curves wit respect to the recessed step 71 without falling down.

The unmanned carrier described in JP-UM-A-6-30807, detecting its entry into a stepped area by way of a sensor, slightly rotates the steering wheel via a steering motor. The unmanned carrier enters the stepped portion in this orientation diagonally with respect to the stepped portion. The unmanned carrier enters the stepped portion at an angle from the direction orthogonal to the stepped portion, so that its wheels cone into point contact with the edge of the stepped portion. The torque exerted when the unmanned carrier goes over the stepped portion is smaller than that in the case of a line contact made when it goes orthogonally to the stepped portion. In other words, a shock assumed when a stepped portion is surmounted is reduced.

A self-traveling cleaning robot has, as self-traveling modes, a wall side traveling mode and a center traveling mode whereby the robot repeatedly travels for example in the shape of the letter U along a planned line in the center of a room excluding the areas near the walls in order to clean the center of the room without leaving an unfinished portion. In particular, in the center traveling mode, for example in case traveling starts along the left wall from the bottom left corner of the room, the travel direction is determined based on the posture (travel direction) of the robot main body positioned at the bottom left corner when the robot is ready to start. Even in case the travel direction is slightly skewed during a travel due to undulations of a carpet or a small obstacle, there is no chance to correct the skewed travel direction. Thus, the robot keeps cleaning in the slightly skewed travel direction, which may leave an unfinished part in the room.

For example, as shown in FIG. 8A, it is assumed that the travel direction 82 of a robot is slightly skewed leftward as shown by chain double-dashed lines in the figure due to a small foreign substance 91 while the robot is traveling on a planned line 81 shown by alternate long and short dashed lines in the figure. In case the robot rotates to the right by 90 degrees, advances by a predetermined distance and rotates to the right by 90 degrees to clean the room floor, the actual travel direction 82 is skewed with respect to the planned line 81, so that the hatched area in the figure is left unfinished.

As shown in FIG. 8B, it is assumed that the travel direction 83 of a robot is slightly skewed rightward as shown by chain double-dashed lines in the figure due to a small foreign substance 91 while the robot is traveling on a planned line 81 shown by alternate long and short dashed lines in the figure. In case the robot rotates to the right by 90 degrees, advances by a predetermined distance and t rotates to the right by 90 degrees to clean the room floor, the actual travel direction 83 is skewed and crosses the planned line 81, so that the robot cleans the same place repeatedly and leaves the remaining areas unfinished.

A self-traveling robot has a stepped portion detection sensor mounted on the bottom of the robot main body in order to detect a stepped portion (especially a recessed step) of a floor. When the stepped portion detection sensor detects a stepped portion, the robot generally stops in the position. The approach of JP-A-2004-139264 is proposed to go around the stepped portion. The approach of JP-UM-A-6-30807 is proposed to go over the stepped portion with reduced shock.

According to the approach of JP-A-2004-139264, cleaning is made along the stepped portion once the stepped portion is detected, so that the center traveling mode is canceled at this time point. Thus, the center of the room is left unfinished after the stepped portion is detected, thus leaving an unfinished portion in the room.

According to the approach of JP-UM-A-6-30807, the robot main body is designed to rotate in one direction by a predetermined angle before traveling diagonally across the stepped portion in order to go over the stepped portion. In this case, after going over the stepped portion, the robot main body may rotate in the opposite direction by a predetermined angle in order to orient the robot in the original travel direction. However, this approach includes a problem that, once the travel direction is slightly skewed while the robot is going over the stepped portion, the skew cannot be corrected. As a result, the robot continues cleaning in the skewed travel direction. That is to say, a slight skew in the travel direction as the robot goes over the stepped portion may leave an unfinished area in the room.

The above problem springs from the circumstances described below. In the center traveling mode whereby the robot repeatedly travels for example in the shape of the letter U along a planned line in the center of a room excluding the areas near the walls in order to clean the center of the room without leaving an unfinished portion, the travel direction is determined without exception based on the posture (travel direction) of the robot main body that is ready to start. Even in case the travel direction is slightly skewed during a travel, there is no chance to correct the skewed travel direction.

### SUMMARY OF THE INVENTION

The invention has been accomplished in view of the above problems. An object of the invention is to provide a self-traveling robot that utilizes, on detecting a stepped portion by a stepped portion detection sensor in a center traveling mode for cleaning the center of a room without leaving an unfinished portion, the stepped portion and also utilizes the stepped portion detection sensor in applications other than detection of a stepped portion in order to correct the posture (travel direction) of the robot main body at that time point.

In order to solve the above problems, the invention provides a self-traveling cleaning robot for cleaning the floor of a room along a predetermined planned line in the room, the self-traveling robot including: a stepped portion detecting unit for detecting a stepped portion of a floor arranged on the center front part of the bottom of the robot main body; an angle detecting unit for detecting the rotation angle of the main body in horizontal direction of the main body; and a travel control unit for controlling a travel based on the detection output of these detection units; wherein the travel control unit stops when a stepped portion is detected by the stepped portion detecting unit, and rotates to the left and to the right in that state thus detecting the rotation angle up to the boundary of the stepped portion in each direction by way of the angle detecting unit, thereby correcting the posture of the robot main body based on the detected angle so that the travel direction of the robot main body will be orthogonal to the stepped portion.

To be more precise, the travel control unit stops when a stepped portion is detected by the stepped portion detecting unit, rotates in one of the left and right directions in that state until the boundary of the stepped portion is detected by the stepped portion detecting unit and stops, rotates in the other direction from the position until the boundary of the stepped portion is detected by the stepped portion detecting unit and stops, as well as detects the rotation angle by way of the angle detecting unit, and rotates in the one direction by half the detected angle and stops, thereby correcting the posture of the robot main body so that the travel direction of the robot main body will be orthogonal to the stepped portion.

According to the invention, a new function to correct the travel direction of a robot by utilizing a stepped portion detected maybe implemented, without additional costs, by using already mounted stepped portion detecting unit and angle detecting unit. By correcting the travel direction while utilizing such a stepped portion, it is possible to re-orient the travel direction along the original planned line. This improves the straight advancing accuracy of travel and solves the above problem, that is, the problems that a slight skew in the travel direction caused by undulations of a carpet or a small obstacle leaves an unfinished portion in the room, thereby thoroughly cleaning the room.

The invention provides a self-traveling cleaning robot for cleaning the floor of a room along a predetermined planned line in the room, the self-traveling robot including: a center stepped portion detecting unit for detecting a stepped portion of a floor arranged on the center front part of the bottom of the robot main body; a wheel stepped portion detecting unit for detecting a stepped portion of a floor arranged in front of each of a left running wheel and a right running wheel at the bottom of the robot main body; an angle detecting unit for detecting the rotation angle of the main body in horizontal direction of the main body; and a travel control unit for controlling a travel based on the detection output of these detection units; wherein the travel control unit stops when a stepped portion is detected by the stepped portion detecting unit, and rotates in one direction until the center stepped portion detecting unit or one wheel stepped portion detecting unit detects the boundary of the stepped portion and stops, rotates in the other direction from the position until the center stepped portion detecting unit or the other wheel stepped portion detecting unit detects the boundary of the stepped portion and stops, as well as detects the rotation angle by way of the angle detecting unit, and rotates in the one direction by half the detected angle and stops, thereby correcting the posture of the robot main body so that the travel direction of the robot main body will be orthogonal to the stepped portion.

In case the center stepped portion detecting unit detects for example a recessed step, the center stepped portion detecting unit projects on the stepped area side below the floor surface by one step where the robot main body is positions. In this case, when the projecting distance is large, rotating the robot main body in one direction (for example left direction) could cause the right running wheel to fall from the stepped portion before the center stepped portion detecting unit detects the boundary of the stepped portion. Thus, the invention also utilizes the wheel stepped portion detecting unit arranged in front of each of the each of the left running wheel and the right running wheel at the bottom of the robot main body to avoid such detailing and correct the travel direction of the robot main body. In this case, a possibility of derailing means that the wheel stepped portion detecting unit detects the boundary of a stepped portion earlier than the center stepped portion detecting unit, that is, the travel direction of the robot may be corrected with a small rotation angle of the robot main body. The travel direction may be corrected in a short time so that it is possible to early resume cleaning along the planned line.

A reflection-type photoreflector is available as the stepped portion detecting sensor. A gyro sensor is available as the rotation angle sensor.

The self-traveling cleaning robot according to the invention is configured as described above. It is thus possible to implement, without additional costs, anew function to correct the travel direction of a robot by utilizing a stepped portion detected by using already mounted stepped portion detecting unit and angle detecting unit. By correcting the travel direction by using a stepped portion, it is possible to re-orient the travel direction along the original planned line. This improves the straight advancing accuracy of travel and solves the above problem, that is, the problems that a slight skew in the travel direction caused by undulations of a carpet or a small obstacle leaves an unfinished portion in the room, thereby thoroughly cleaning the room. It is thus possible to provide the user a self-traveling cleaning robot excellent in terms of cleaning performance.

### BRIEF DESCRIPTION OF THE DRAWINGS

These and other objects and advantages of this invention will become more fully apparent from the following detailed description taken with the accompanying drawings in which:

FIG. 1A is a front schematic view of the external configuration of a self-traveling cleaning robot according to this invention;

FIG. 1B is a top schematic view of the external configuration of a self-traveling cleaning robot according to this invention;

FIG. 1C is a bottom schematic view of the external configuration of a self-traveling cleaning robot according to this invention;

FIG. 2 is a functional block diagram showing the electrical configuration of the self-traveling cleaning robot according to this invention;

FIG. 3 is a flowchart showing one embodiment of the travel direction correction control by the self-traveling cleaning robot according to this invention;

FIGS. 4A to 4D illustrate the operation of a robot main body according to the one embodiment;

FIG. 5 is a flowchart showing other embodiment of the travel direction correction control by the self-traveling cleaning robot according to this invention;

FIGS. 6A to 6D illustrate the operation of the robot main body according to the other embodiment;

FIGS. 7A to 7C show the operation assumed when a stepped portion is detected by a related art self-traveling cleaning robot; and

FIGS. 8A and 8B illustrate the problems arising when the travel direction of the related art self-traveling cleaning robot is slightly skewed leftward due to a small foreign substance while it is traveling along a planned line.

### DETAILED DESCRIPTION OF THE PREFERRED EMBODIMENTS

Embodiments of the invention will be described referring to drawings.

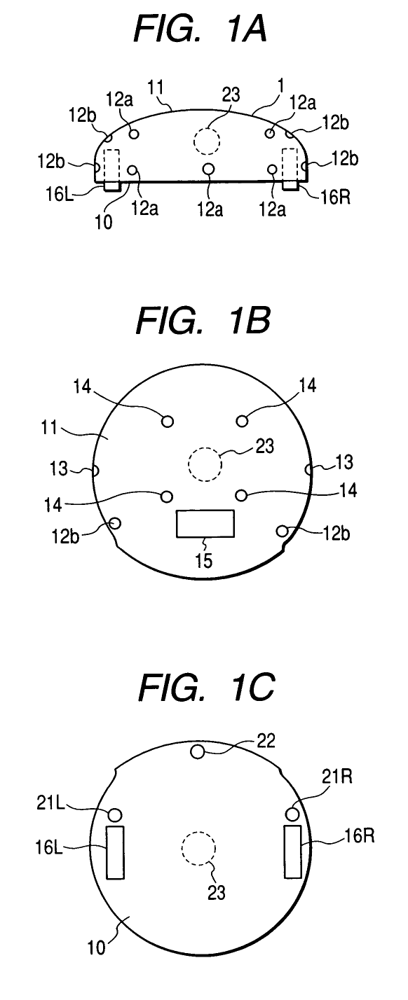

FIGS. 1A to 1C are schematic views of the external configuration of a self-traveling cleaning robot according to this embodiment. FIG. 1A shows a front view, FIG. 1B a top view and FIG. 1C a bottom view.

The self-traveling cleaning robot has an almost disc-shaped bottom part 10 of a robot main body 1. A main body part 11 continuous from the periphery of the bottom 10 has a shape of a dome. At the front lower of the main body part 11 are arranged for example a plurality of (12 in this embodiment) ultrasonic sensors 12a for detecting an obstacle in the travel direction. At each of the left and right side faces of the main body part 11 are arranged a plurality of (2 in this embodiment) ultrasonic sensors 12b for detecting an obstacle in the diagonal front direction and a single ultrasonic sensor 13 for detecting a side wall. On the top face of the main body part 11 are arranged a plurality of (4 in this embodiment) human body sensors (such as infrared sensors) 14 as well as a switch operation part 15 including various types of operation switches.

At the bottom 10 are arranged a left running wheel 16L and a right running wheel 16R to the left and right of an approximate center, respectively. In front of the left running wheel 16L and the right running wheel 16R are arranged a left wheel photoreflector 21L and a right wheel photoreflector 21R as stepped portion detecting sensors for detecting a stepped portion of a floor. At the center front of the bottom 10 is arranged a center photoreflector 22 as a stepped portion detecting sensor for detecting a stepped portion of a floor. A photoreflector is a reflection-type optical sensor including a light emitter and a light receiver. The photoreflector irradiates optical pulses from a light emitter and receives a reflected light returning from an object and measures the light receiving intensity to measure the distance to the object (in this case a floor).

Inside the main body part 11 is arranged a gyro sensor 23 (shown by broken lines) for detecting the rotation angle of the robot main body 1 in horizontal direction.

While not shown, in the internal of the main body part 11 are provided a wheel drive part for individually driving the running wheels 16L, 16R, a control board for controlling the robot main body 1 based on detection signals from the sensors, and various functions necessary for cleaning.

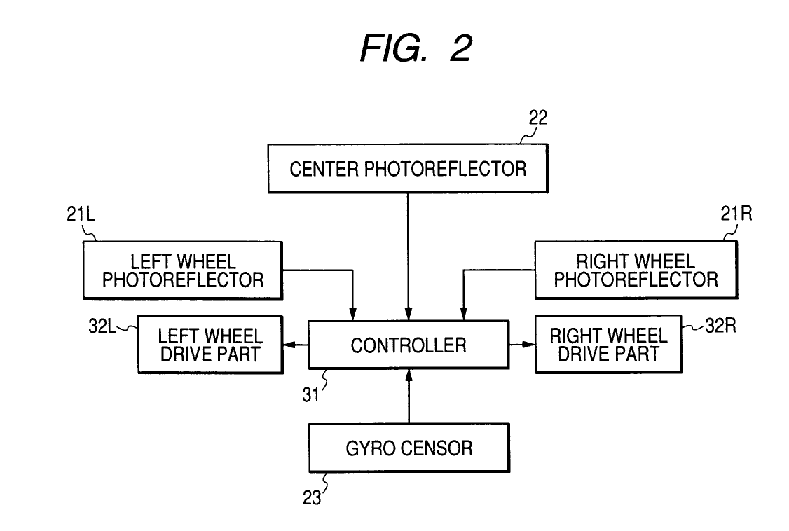

FIG. 2 is a functional block diagram showing the electrical configuration of the self-traveling cleaning robot of the above configuration. Note that FIG. 2 shows functions related to the invention alone.

To a controller 31 for controlling the overall operation of the self-traveling cleaning robot are connected the sensor outputs of a center photoreflector 22, a left wheel photoreflector 21L, a right wheel photoreflector 21R, and a gyro sensor 23. A left wheel drive part 32L for performing drive control of the left running wheel 16L and a right wheel drive part 32R for performing drive control of the right running wheel 16R are also connected to the controller 31. The controller 31 is composed of a CPU, a ROM, and a RAM. The RAM stores thereon an operation program for performing travel control and cleaning control of a robot. The operation program stores a travel direction correction control program that uses a stepped portion as a characteristic of this invention.

Described below is an example of travel direction correction control assumed in case a stepped portion is detected while the self-traveling cleaning robot of the above configuration is cleaning the floor of a room while self-traveling along a predetermined line in the room.

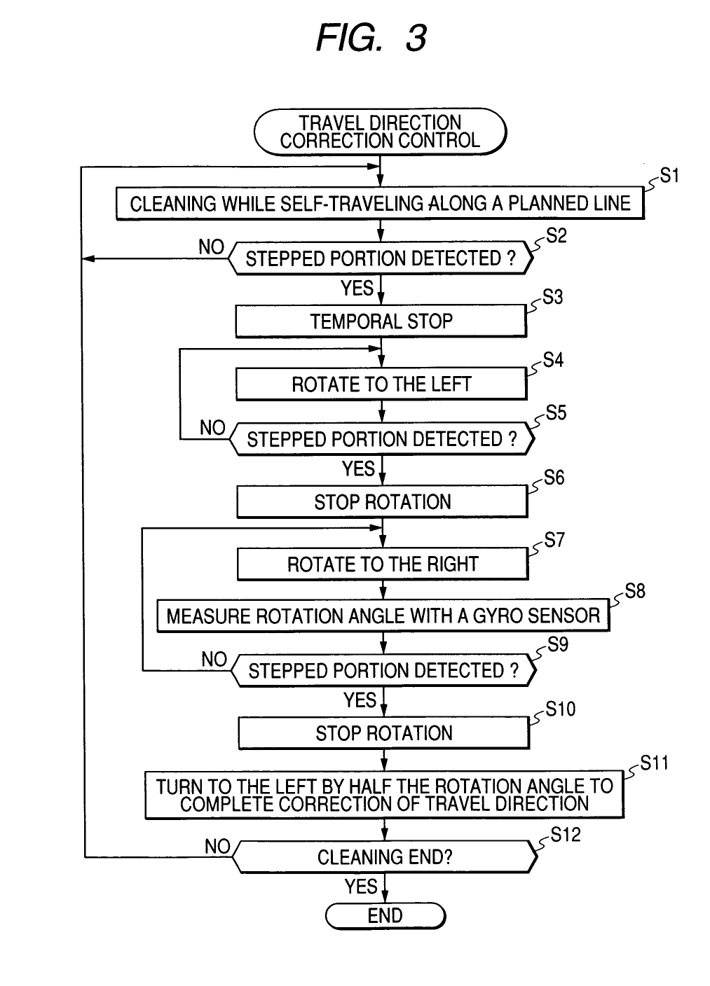

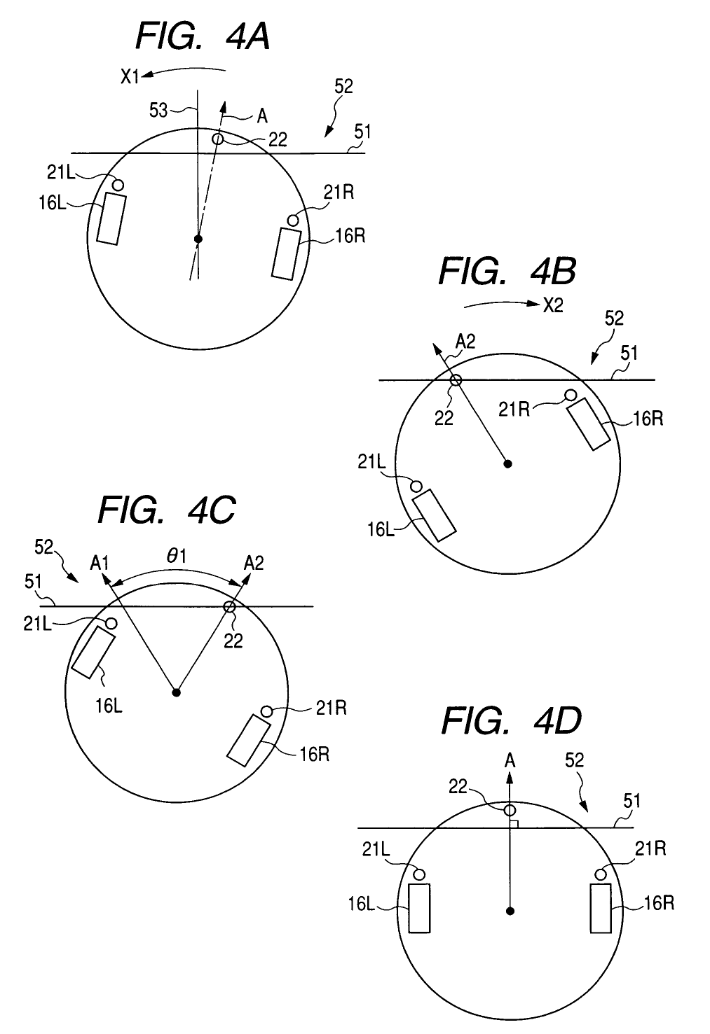

Embodiment 1 of the travel direction correction control will be described referring to the flowchart in FIG. 3 and the drawing illustrating the operation of the robot main body 1 shown in FIGS. 4A to 4D.

While the self-traveling cleaning robot is cleaning the floor of a room while self-traveling along a predetermined line in the room (step S1), on detecting a stepped portion (recessed step in this example) by the center photoreflector 22 (Yes in step S2), the controller 31 performs drive control of the left wheel drive part 32L and the right wheel drive part 32R and temporarily stops (step S3). FIG. 4A shows this state. A numeral 51 in the figure shows the boundary of the stepped portion and the part higher than the boundary 51 is a lower stepped area 52. In this state, the center photoreflector 22 slightly projects toward the stepped area 52 from the boundary 51 of the stepped portion. In this example, it is assumed that the travel direction (arrow sign A in the figure) is slightly skewed from a direction 53 orthogonal to the boundary 51.

In this state, the controller 31 reversely rotates (drives backward) the left wheel drive part 32L and normally rotates (drives forward) the right wheel drive part 32R to rotate the robot main body 1 to the left (arrow sign X1 in FIG. 4A) (step S4), and rotates until the center photoreflector 22 detects the boundary 51 of the stepped portion (until step S5 ends with Yes), and stops (step S6). FIG. 4B shows this state. The sign A1 in the figure shows the travel direction of the robot main body 1 at this time point.

From the position, the controller 31 normally rotates (drives forward) the left wheel drive part 32L and reversely rotates (drives backward) the right wheel drive part 32R to rotate the robot main body 1 to the right (arrow sign X2 in FIG. 4B) (step S7). At the same time as the start of rotation, the controller 31 starts to measure the rotation angle by way of the gyro sensor 23 (step S8). The controller 31 rotates to the right until the center photoreflector 22 detects the boundary 51 of the stepped portion again (until step S9 ends with Yes), and stops (step S10). FIG. 4C shows this state. The sign A2 in the figure shows the travel direction of the robot main body 1 at this time point. As a result of the rotation of the robot main body 1 from A1 to A2, the angle detected by the gyro sensor 23 is θ1.

Then the controller 31 rotates to the left by half the detected angle θ1 (θ1/2) and stops (step S11). As a result, as shown in FIG. 4D, the posture of the robot is corrected so that the travel direction A of the robot main body 1 will be orthogonal to the boundary 51 of the stepped portion. The robot cleans the floor of the room while self-traveling along the planned line. When a stepped portion is detected, the above processing (steps S1 through S11) is carried out. Such processing is repeated until cleaning is complete (until step S12 ends with Yes).

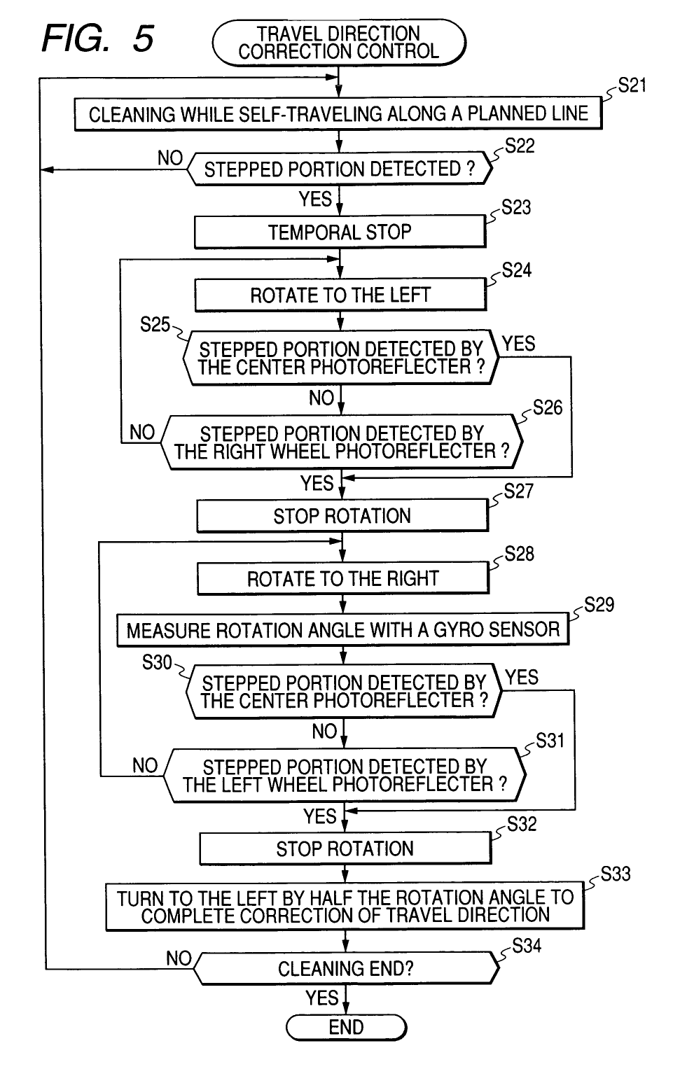

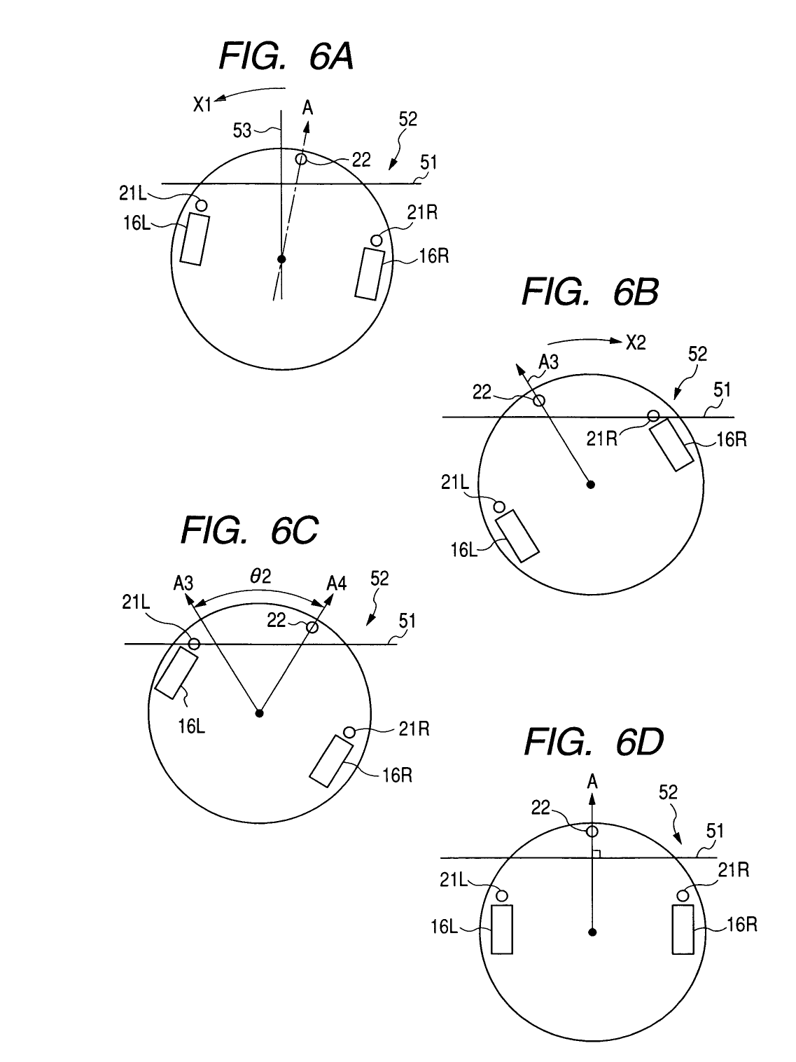

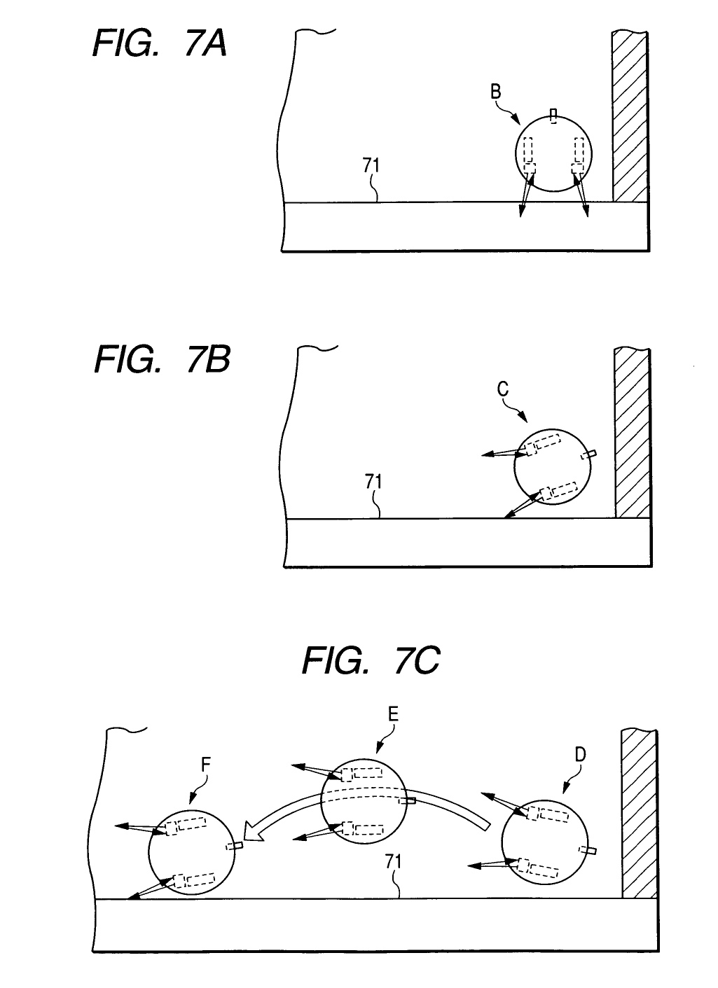

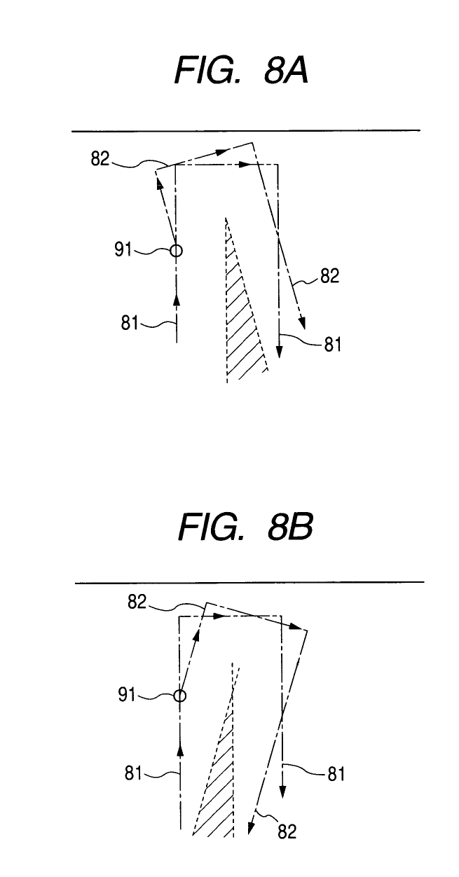

Embodiment 2 of the travel direction correction control will be described referring to the flowchart in FIG. 5 and the drawing illustrating the operation of the robot main body 1 shown in FIGS. 6A to 6D.

In case the projecting distance is large when the center photoreflector 22 has detected a stepped portion (recessed step in this example), rotating the robot main body 1 in this state could cause a running wheel to detail before the center photoreflector 22 detects the boundary 51 of the stepped portion. Thus, Embodiment 2 uses the left wheel photoreflector 21L and the right wheel photoreflector 21R arranged in front of the running wheels to avoid such derailing and corrects the travel direction of the robot main body.

While the self-traveling cleaning robot is cleaning the floor of a room while self-traveling along a predetermined line in the room (step S1), on detecting a stepped portion (recessed step in this example) by the center photoreflector 22 (Yes in step 2), the controller 31 performs drive control of the left wheel drive part 32L and the right wheel drive part 32R and temporarily stops (step S3). FIG. 4A shows this state. A numeral 51 in the figure shows the boundary of the stepped portion and the part higher than the boundary 51 is a lower stepped area 52. In this state, the center photoreflector 22 slightly projects toward the stepped area 52 from the boundary 51 of the stepped portion. In this example, it is assumed that the travel direction (arrow sign A in the figure) is slightly skewed from a direction 53 orthogonal to the boundary 51.

In this state, the controller 31 reversely rotates (drives backward) the left wheel drive part 32L and normally rotates (drives forward) the right wheel drive part 32R to rotate the robot main body 1 to the left (arrow sign X1 in FIG. 6A) (step S24), and rotates until the center photoreflector 22 or the right wheel photoreflector 21R detects the boundary 51 of the stepped portion (until step S25 ends with Yes or step S26 ends with Yes), and stops (step S27). FIG. 6B shows this state. In this example, the right wheel photoreflector 21R detects the boundary 51 of the stepped portion earlier than the center photoreflector 22. In other words, the right running wheel 16R stops rotation just before it derails. The sign A3 in the figure shows the travel direction of the robot main body 1 at this time point.

From the position, the controller 31 normally rotates (drives forward) the left wheel drive part 32L and reversely rotates (drives backward) the right wheel drive part 32R to rotate the robot main body 1 to the right (arrow sign X2 in FIG. 6B) (step S28). At the same time as the start of rotation, the controller 31 starts to measure the rotation angle by way of the gyro sensor 23 (step S29). The controller 31 rotates to the right until the center photoreflector 22 or the left wheel photoreflector 21L detects the boundary 51 of the stepped portion (until step S30 ends with Yes or step S31 ends with Yes), and stops (step S32). FIG. 6C shows this state. In this example, the left wheel photoreflector 21L detects the boundary 51 of the stepped portion earlier than the center photoreflector 22. In other words, the left running wheel 16L stops rotation just before it derails. The sign A4 in the figure shows the travel direction of the robot main body 1 at this time point.

As a result of the rotation of the robot main body 1 from A3 to A4, the angle detected by the gyro sensor 23 is θ2.

Then the controller 31 rotates to the left by half the detected angle θ2 (θ2/2) and stops (step S33). As a result, as shown in FIG. 6D, the posture of the robot is corrected so that the travel direction A of the robot main body 1 will be orthogonal to the boundary 51 of the stepped portion. The robot cleans the floor of the room while self-traveling along the planned line. When a stepped portion is detected, the above processing (steps S21 through S33) is carried out. Such processing is repeated until cleaning is complete (until step S34 ends with Yes).

While the right wheel photoreflector 21R or the left wheel photoreflector 21L detects the boundary 51 of the stepped portion earlier than the center photoreflector 22 in Embodiment 2, as a rare case, the center photoreflector 22 and either the right wheel photoreflector 21R or the left wheel photoreflector 21L detects the boundary 51 of the stepped portion at the same time. In such a case, the detection result of the center photoreflector 22 or the right wheel photoreflector 21R or the left wheel photoreflector 21L may be used to perform control.

While leftward rotation is followed by rightward rotation in case a stepped portion is detected in Embodiment 1 and Embodiment 2, the order of rotation may be reversed. That is, rightward rotation may be followed by leftward rotation. While the stepped portion is a recessed step in Embodiment 1 and Embodiment 2, travel direction correction control is also possible by similar a control procedure even in case the stepped portion is a projecting step.

What is claimed is:

1. A self-traveling cleaning robot for cleaning the floor of a room along a predetermined planned line in the room, the self-traveling robot comprising:
a center photoreflector for detecting a stepped portion of a floor arranged on the center front part of the bottom of the robot main body;
a wheel photoreflector for detecting a stepped portion of a floor arranged in front of each of a left running wheel and a right running wheel at the bottom of the robot main body;
a gyro sensor for detecting the rotation angle of the main body in horizontal direction of the main body; and
a travel control unit for controlling a travel based on the detection output of the center photoreflector, the wheel photoreflector and the gyro sensor, wherein
the travel control unit stops when a stepped portion is detected by the center photoreflector, and rotates in one direction until the center photoreflector or one wheel photoreflector detects the boundary of the stepped portion and stops, rotates in the other direction from the position until the center photoreflector or the other wheel photoreflector detects the boundary of the stepped portion and stops, as well as detects the rotation angle by way of the gyro sensor, and rotates in the one direction by half the detected angle and stops, thereby correcting the posture of the robot main body so that the travel direction of the robot main body will be orthogonal to the stepped portion.

2. A self-traveling cleaning robot for cleaning the floor of a room along a predetermined planned line in the room, the self-traveling robot comprising:
a stepped portion detecting unit for detecting a stepped portion of a floor arranged on the center front part of the bottom of the robot main body;
an angle detecting unit for detecting the rotation angle of the main body in horizontal direction of the main body; and
a travel control unit for controlling a travel based on the detection output of the stepped portion detecting unit and the angle detecting unit, wherein
the travel control unit stops when a stepped portion is detected by the stepped portion detecting unit, and rotates to the left and to the right in that state thus detecting the rotation angle up to the boundary of the stepped portion in each direction by way of the angle detecting unit, thereby correcting the posture of the robot main body based on the detected angle so that the travel direction of the robot main body will be orthogonal to the stepped portion.

3. The self-traveling cleaning robot according to claim 2, wherein
the travel control unit stops when a stepped portion is detected by the stepped portion detecting unit, rotates in one of the left and right directions in that state until the boundary of the stepped portion is detected by the stepped portion detecting unit and stops, rotates in the other direction from the position until the boundary of the stepped portion is detected by the stepped portion detecting unit and stops, as well as detects the rotation angle by way of the angle detecting unit, and rotates in the one direction by half the detected angle and stops, thereby correcting the posture of the robot main body so that the travel direction of the robot main body will be orthogonal to the stepped portion.

4. The self-traveling cleaning robot according to claim 2, wherein
the stepped portion detecting sensor is a photoreflector and the stepped portion detecting sensor is a gyro sensor.

5. A self-traveling cleaning robot for cleaning the floor of a room along a predetermined planned line in the room, the self-traveling robot comprising:
a center stepped portion detecting unit for detecting a stepped portion of a floor arranged on the center front part of the bottom of the robot main body;
a wheel stepped portion detecting unit for detecting a stepped portion of a floor arranged in front of each of a left running wheel and a right running wheel at the bottom of the robot main body;
an angle detecting unit for detecting the rotation angle of the main body in horizontal direction of the main body; and
a travel control unit for controlling a travel based on the detection output of the center stepped portion detecting unit, the wheel stepped portion detecting unit and the angle detecting unit, wherein
the travel control unit stops when a stepped portion is detected by the stepped portion detecting unit, and rotates in one direction until the center stepped portion detecting unit or one wheel stepped portion detecting unit detects the boundary of the stepped portion and stops, rotates in the other direction from the position until the center stepped portion detecting unit or the other wheel stepped portion detecting unit detects the boundary of the stepped portion and stops, as well as detects the rotation angle by way of the angle detecting unit, and rotates in the one direction by half the detected angle and stops, thereby correcting the posture of the robot main body so that the travel direction of the robot main body will be orthogonal to the stepped portion.
